(19) United States
(12) Patent Application Publication
(10) Pub. No.: US 2025/0272660 A1
(43) Pub. Date: Aug. 28, 2025

(54) AUTOMATED ROADMAP CONTENT CREATION

(71) Applicant: JP Morgan Chase Bank, N.A., New York, NY (US)

(72) Inventors: Laura SCHORNACK, Oak Park, IL (US); Pratima BALAKUMAR, Naperville (IL); Mehmet DONER, Schaumburg, IL (US); Radhakrishnan SETHURAMAN, Aurora, IL (US); Nina HESSE, Chicago, IL (US); Daniel MONTGOMERY, Vernon Hills, IL (US); Evelyn SALAHUDDIN, Chicago, IL (US)

(73) Assignee: JP Morgan Chase Bank, N.A., New York, NY (US)

(21) Appl. No.: 18/587,807

(22) Filed: Feb. 26, 2024

(51) Int. Cl. G06Q 10/10; G06F 8/65; G06F 8/71

(52) U.S. Cl. CPC G06Q 10/103; G06F 8/65; G06F 8/71

(57) ABSTRACT

A method for automating roadmap software content creation is provided. The method may include gathering data, by at least one processor, from one or more data sources; filtering, by the at least one processor, the data based on a predetermined criteria to identify one or more requests to update a software application being unsupported by an external cloud environment; and creating content automatically for a roadmap software tool, based on the one or more requests, by using a content generating workflow software tool.

### FIELD OF TECHNOLOGY

The present disclosure generally relates to a roadmap software application and, more particularly, to automating roadmap software content creation.

### BACKGROUND

Driven by the benefits of scalability, simplified disaster recovery, cost savings, and resource optimization, cloud computing has grown exponentially over the past several years. As companies migrate to external cloud computing, they want to remove the manual steps of keeping their virtual private cloud (VPC) environment up to date. The VPC is a secure, isolated private cloud hosted within the external public cloud. VPCs combine the scalability and convenience of public cloud computing with the data isolation of private cloud computing.

In a cloud environment, the VPC infrastructure needs to be proactively maintained and monitored on a regular basis to handle tasks, such as managing upgrades and version updates for a software application. Examples of software maintenance include certificate expiry, license key expiry, and software version hygiene. Otherwise, the application, product, or system can malfunction. Updates or upgrades can be released often, and keeping up with them can be challenging. Currently, different teams within an enterprise, such as a financial institution, have the responsibility of tracking and managing these update tasks by manually checking to determine whether a new version of an application, a software application dependency, or both is available.

To maintain these updates, there is a need to automate the process of adding items into the backlogs of development teams when changes to the environment occur. An example of a change that affects the cloud environment is when a version of a software application is being deprecated in the external cloud environment. A program or application that is deprecated is no longer supported or maintained by its developer hence it is not advisable to use it. Deprecated software is usually replaced or updated with a newer version. Thus, the developers need to have a work item added to their backlog to upgrade their code before the software is deprecated to avoid a malfunction.

A strategic product roadmap, which is typically prepared by a project manager or a project owner, drives prioritization of the backlog for the development team. Generally, the development team uses the product map to understand the product strategy, how it connects to goals, and why initiatives have been prioritized. The roadmap should be updated often so that it remains accurate, because a roadmap is counter-productive if it is not up to date.

The product roadmap communicates high-level strategic objectives and priorities, and the product backlog is a list of tasks that serve the roadmap's strategic plan. The roadmap conveys the strategy, and the backlog conveys the plan to implement it. The product backlog lists and prioritizes the task-level details required to execute the strategic plan set forth in the roadmap. Typical items on a product backlog include product stories, software updates, bug fixes, and other tasks.

Currently, when resources are deployed in-house within an internal infrastructure and an internal cloud environment, all update information is tracked manually by teams of project managers. However, one big mistake when migrating into an external cloud environment is using the same process long established with the internal in-house infrastructure. Using these same old in-house procedures can lead to taking these same bad habits of manual updates to the external cloud which should be avoided.

### SUMMARY

Given the aforementioned deficiencies, there is a need for a tool to automatically track and capture updates, for example, regarding expiry data in an external cloud environment and automatically approving and adding these updates to the roadmaps to be fed directly to the backlog of the development teams. The present disclosure, through one or more of its various aspects, embodiments, and/or specific features or sub-components, provides, inter alia, various systems, servers, devices, methods, media, programs, and platforms for automatically tracking and capturing updates in an external cloud environment and automatically approving and adding these updates to the roadmaps to be fed directly to the backlog of development teams. Creating a workflow for product owners to approve these items, and after the approval to be added to the roadmaps that feed the backlog. This is necessary, because without the product owner's approval, the developers cannot work on the backlog items. An approval workflow is necessary.

Various embodiments provide a method and system for automatically identifying and gathering data requiring updates in an external cloud environment and feeding the update data, such as expiry data, to an internal cloud environment for a roadmap.

According to an aspect of the present disclosure, a method for delivering services to data sources on an unmanaged cloud environment is provided. The method may be implemented by at least one processor. The method may include gathering data from the data sources; filtering the data based on a predetermined criteria to identify requests to update a software application being unsupported by an external cloud environment; and creating content automatically for a roadmap software tool, based on the requests, by using a content generating workflow software tool.

The predetermined criteria may include deprecation data comprising a deprecation status indicative of the software application being unsupported by the external cloud environment. The deprecation data may include one or more attributes to identify the software application.

The software application being unsupported may be an internal software application running on at least one of a virtual private cloud, an internal cloud environment, and an internal computing environment.

In accordance with an exemplary embodiment, the content generating workflow software may further comprise creating a roadmap items account list by mapping a list of external cloud accounts being unsupported by the external cloud environment to a list of internal accounts on the internal cloud environment.

The roadmap items account list may be sent from the content generating workflow software tool on the external cloud environment to an internal workflow tool on the internal cloud environment for approval to add one or more of the requests as one or more work items to the roadmap software tool.

In accordance with an exemplary embodiment, after approval, one or more work items may be added to the roadmap software tool. The one or more work items may be filtered and prioritized to a work queue of the roadmap software tool to update the feature of the software application being unsupported by the external cloud environment.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for the purpose of illustrating the embodiments and are not to be construed as limiting the disclosure. Given the following enabling description of the drawings, the novel aspects of the present disclosure should become evident to a person of ordinary skill in the relevant art(s).

FIG. 1 shows an exemplary system for implementing a method for automatically creating content for a roadmap software tool.

FIG. 2 is a diagram that illustrates a process flow usable for implementing a method for automatically creating content for a roadmap software tool, according to an exemplary embodiment.

FIG. 3 is a diagram that illustrates another process flow usable for implementing a method for automatically creating content for a roadmap software tool, according to an exemplary embodiment.

FIG. 4 is an exemplary diagram of a system that is usable for implementing a method for automatically delivering services to update data sources on an unmanaged cloud environment, according to an exemplary embodiment.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As described herein, various embodiments provide optimized methods and systems for automating content creation of a roadmap software application.

Various embodiments are directed to a system and method for ingesting data from a lifecycle management process into a roadmap software application. The term lifecycle management (LCM), which may also be referred to as Technology Lifecycle Management (TLM) or Application Lifecycle Management (ALM), refers to all types of strategic process of managing a software or product lifecycle from initial idea through design, development, testing, deployment, and end-of-life.

The LCM process is the entire lifecycle from the creation and maintenance of a software application until it is no longer used. There are five stages in an application's lifecycle: application requirement gathering; application development; application testing; application deployment; and application maintenance. In the maintenance phase, the support and development teams work together to resolve any bugs, plan new updates and further improve the product. Feedback and new features can be incorporated into the product. Over time, a new application may be released, and the current application may be discontinued.

The current LCM process for external cloud computing is a very manual and ad-hoc process. An example of an LCM item for an external cloud is when the external cloud will no longer support a version or feature of the software or application and the appropriate internal groups of the company needs to be aware of the deprecation. Currently, there is no clear process to add any external cloud LCM items to the roadmaps and the backlogs of teams.

Automating this process using an automated roadmap content creation (ARCC) tool reduces work and ensures accuracy as described herein. The system and method automates the intake of the LCM items into the strategic backlog tooling (specifically, as a feature request) which will then be fed to the strategic backlogs in the Line of Businesses (LOBs) through the roadmap tool.

One of the purposes of the system and method described herein is to provide an automated process to populate the roadmaps all the way through the process of the LOB instance. An instance is a single installation of a self-contained copy of a specific product.

Various embodiments automate the population of the roadmap tool by pushing requests (such as a feature request) into an approval workflow to determine whether or not to add these items to the backlogs by approving the request in the work approval tool.

Various embodiments provide an ARCC tool which is a developer advocacy tool that automates tracking incoming feature requests from multiple sources. After approval of the feature request, it will be fed into the appropriate roadmap. The roadmap can filter and prioritize the feature requests.

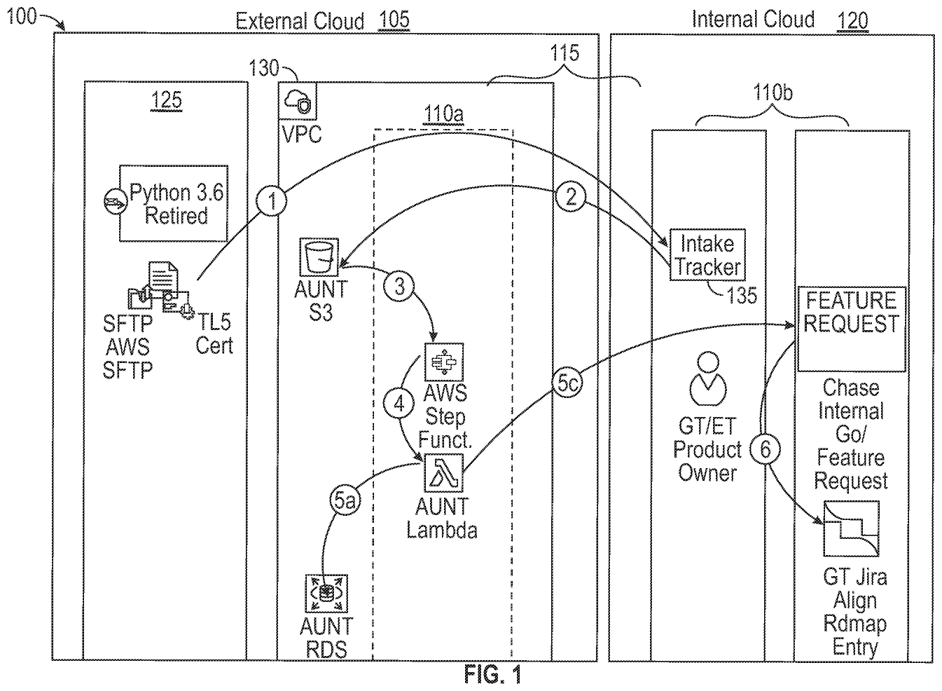

FIG. 1 is a diagram showing the inputs and outputs of a system environment 100 for automatically creating content for a roadmap software tool. As shown in FIG. 1, in one aspect, the system environment 100 may include an external cloud environment 105, a workflow tool 110a, 110b of an ARCC tool 115, and an internal cloud environment 120. In some embodiments, the internal cloud environment 120 is connected to the external cloud environment 105 through a network, such as a communication network, for example. In FIG. 1, the ARCC tool 115 may include one or more components that operate within the workflow tool 110a, 110b residing in and/or executed by one or more computer resources in the external cloud environment 105 and the internal cloud environment 120. In this exemplary embodiment, the workflow tool 110a may be a content generating workflow software tool that resides on the external cloud environment 105. The workflow tool 110b may be an internal workflow tool that resides on the internal cloud environment 120.

As used herein, an internal cloud environment 120 may include a private cloud computing platform operated by a single entity for use by the single entity. The internal cloud computing platform may communicate with and transfer data between the internal cloud computing platform, other internal cloud computing platforms, and third-party external cloud computing platforms. In another exemplary embodiment, the internal cloud computing platform may utilize computing architectures similar to external cloud computing platforms. However, the internal cloud computing platform may not provide services such as, for example, data processing and data storage services for third-party entities. In another exemplary embodiment, the internal cloud computing platform may utilize proprietary computing architectures developed by the operating entity.

The internal cloud environment 120 may provide services that includes, for example, remote monitoring, automated routine tasks such as configurations and software upgrades, an asset management database, and handling of tasks. For instance, in internal cloud environment 120, the cloud infrastructure is proactively maintained and monitored on a regular basis to handle tasks, such as managing upgrades and version updates for software applications. The internal services can be provided using a combination of human and artificial intelligence working together to monitor devices and maintain all hardware and software in use, while simultaneously identifying potential problems and addressing them before they can cause a negative impact to the system.

In FIG. 1, the external cloud environment 105 may include an external application that is maintained in an external cloud computing platform 125 and generated by using a content management platform. The external cloud computing platform 125 may include a third-party cloud computing platform such as, for example, an AMAZON Web Services (AWS) cloud computing platform, a GOOGLE Cloud platform, and a MICROSOFT AZURE cloud computing platform that provides on-demand computer system resources via a network, such as, for example, the Internet.

In some embodiments, the external cloud environment 105 may define distinct private networks. The private networks may be logically isolated virtual networks that are isolated from each other. One or more private networks may be associated with the same entity or different entities. A client's private network may be configured as a Virtual Private Cloud (VPC) 130 that provides the client full control over its virtual networking environment, including resource placement, connectivity, and security. Accordingly, the resources can be defined and launched in a logically isolated private network. Various embodiments can include one or more VPCs 130.

The private network may include communication devices. In some embodiments, the communication devices may take the form of servers, general purpose computers, and mainframe computers. In some embodiments, the communication devices may take the form of mobile computing devices such as smartphones, tablets, and laptop computers. Alternatively, the communication devices may be configured as particular apparatus, embedded systems, dedicated circuits, or the like, based on the storage, execution, and/or implementation of the software instructions that perform operations consistent with the disclosed embodiments.

In the example of FIG. 1, a user, such as a financial institution of internal cloud environment 120, can migrate and join the external cloud environment 105 as a customer to access the resources, services, and data provided by the external cloud environment 105. The various embodiments of the present disclosure may be applied to other industries that use project management strategies, including technology companies and health care businesses.

When applied to any type of business application, the present system and method provides a well-managed environment that is up to date with all software application versions in the environment and is aware of what needs to be upgraded and when for all components. As an example, at some point, all software becomes deprecated as new versions are released and older ones are no longer supported. When a new version is released, an expiration date is announced for the previous version. A version is considered deprecated once its expiration date has been announced. Example of products on the external cloud environment 105 that may be scheduled for deprecation include a library dependency, a license, or a certificate that needs to be updated.

In various embodiments, the system and method automates the intake of LCM items wherein the LCM is capable of supporting regulated industries, including banking and financial, medical and pharmaceutical, and aerospace and defense, that must align to the regulations of different regulatory authorities. These regulations may govern the auditability of the software development process and the safety and quality of the end products. The system and method described herein is capable of providing a comprehensive governance framework that supports software development and maintenance in regulated industries.

The system and method of the present disclosure eliminates the conventional approach of manually adding these updates to the roadmaps. Instead, the embodiments implement a system and method that automates the population of a roadmap tool by pushing requests (such as a feature request) into an approval workflow to determine whether or not to add these items to the backlogs by approving the request in the work approval tool. The method for automatically tracking and capturing updates in an external cloud environment and automatically approving and adding these updates to the roadmaps to be fed directly to the backlog of the development teams may be implemented by the ARCC tool 115.

The ARCC tool 115 may be configured as a developer advocacy tool that automates tracking incoming feature requests from multiple sources. After approval of the feature request, it will be fed into the appropriate roadmap. The roadmap can filter and prioritize the feature requests. It will be understood that, given that what is being described herein is the ARCC tool, rather than the process from the roadmap to feeding the backlogs of the development teams, the details of the backlog itself are beyond the scope of this document.

Thus, in FIG. 1, one solution discussed herein is to implement at block 1 an intake process at an internal cloud environment 120 to capture and track information received from an external cloud environment 105. An intake tracker 135 may be used during the intake process to receive at the internal cloud environment 120 various inputs, such as requests, inquiries, and events. The input data may include, for example, request/event name, source of request, request/event type, brief description, reason for event, line of business, project status and/or Global Technology (GT) ownership.

In various embodiments, alternatively or in addition to the inputs received from the external cloud environment 105 during the intake process, internal inputs may be received from the internal cloud environment 120 at the input tracker 135. The internal inputs can be received from a multitude of mechanisms, techniques, and tools.

At block 2, the input data is transferred from the input tracker 135 of the internal cloud environment 120 to the workflow tool 110a residing in the external cloud environment 105. Then, the input data is filtered. The input data may be filtered in various ways. For example, the input data received from the external cloud environment 105, the internal cloud environment 120, or both may include expiry data or LCM data, such as data regarding an announcement of the release of a new version of a software and an expiration date for the previous version. For example, the expiry data may include one or more expiration attributes to identify at least one of: an expiration date, the expiration date indicating a date when the data source is no longer available; a software version number associated with the expiration date; and a new software version of the data source at the external cloud environment 105.

Thus, in block 2, the expiry data regarding an “end of life” announcement information may be applied as a search filter. Namely, the process determines whether the input data is an “end of life” or LCM type of activity that requires action. The process can employ various techniques to filter for the expiry data. In an embodiment, the process can apply a search filter for relevant terms or key phrases to search for the expiry data. In some embodiments, the data may be filtered using, for example, machine learning, natural language processing (NLP) and/or tree type algorithms techniques.

Block 3 is optional, but in some embodiments it may be useful for entities that have central management of generic technology product lines, such as “databases” or “cloud offerings.” In block 3, the process needs to understand the Global Technology (GT) ownership to update the software or application that needs to be upgraded by mapping to the GT product. The GT ownership lists the ownership data for cloud-based technologies. To create a GT product map, the intake process may involve providing details for an offering about a product into the system, which includes offering name, offer description, overview of functionality, version number, and organizational details. To create the GT product map, the process maps data of at least one software or application to be upgraded to the GT product ownership data. In action node 3, the process may utilize a set of maps that maps to different data of the GT product based, for example, on the offering name or other user preferences.

In block 4, the process may obtain a list of accounts within the company or entity that are using the software or application that needs to be upgraded. For example, the workflow tool 110a can create the content by generating a list of accounts for the software application being unsupported by the external cloud environment. The workflow tool 110a can a list of external cloud accounts for private computing resources hosted on the external cloud environment for exclusive use by a user in the VPC 130, by performing a software check on the private computing resources to determine the list of external cloud accounts associated with the software application being unsupported by the external cloud environment. The workflow tool 110a can determine software programs installed on the external cloud environment 105 that are actively running or inactive and needing updates. In an embodiment the workflow tool 110a can determine the list of external cloud accounts by mapping the list of external cloud accounts to line of business products with global technology ownership data.

In some embodiments, a list of internal accounts may be retrieved from a database within the internal systems. The internal system 105 may include other internal applications, as well. The process can also obtain a list of internal accounts from an identification number application that maintains an internal software list, including software version and depreciation data indicating when a software application deprecates on the internal cloud environment 120.

The workflow tool 110a can further create the content by creating a roadmap items account list by mapping the list of external cloud accounts to the list of internal accounts.

In block 5a, the list of roadmap items account list may be stored in a database within the external cloud environment. After the roadmap items account list which identifies the internal products that need to be updated has been generated, in block 5b, the roadmap items account list from the workflow tool 110a in the external cloud environment 105 may be sent to an internal workflow 110b in the internal cloud environment 120 to notify a business owner or product owner to add a work item for each internal product on the list for an update into their roadmap.

In block 6, in some systems, an internal product, such as a feature request tracking tool or a convey tool can be used to send the communications of the workflow tools from the external cloud environment to the internal cloud environment.

To automate the process of keeping the roadmap up to date so that it remains accurate, in embodiments, the feature request tracking tool can be used to track feature requests and inject roadmap items into the roadmap tool. A disposition and/or approval may be applied to the feature request to determine whether to inject the update item into the roadmap tool. The feature request may be assigned, for example, to a product owner for disposition and/or approval.

In other embodiments, the approval may be an automated process conducted by, for example, at the internal workflow tool. In some embodiments, the approval may be an automated process performed at the internal workflow tool. The disposition options may include approve, conduct further research and/or evaluation, return to submitter or author requiring additional information, reject request, request not recommended, and request already exists in roadmap tool.

If approved, the feature request is injected into the roadmap tool. The roadmap tool communicates high-level strategic objectives and priorities for projects that the business has committed to. In an embodiment, the roadmap tool may be a project management tool. In some embodiments, the project management tool can include a feature request tracking tool to track feature requests and inject feature request items into the roadmap tool.

One embodiment provides a roadmap tool, such as JIRA, that works at the level of a team. Another embodiment provides a roadmap tool, such as JIRA Align, that works on a larger scale to coordinate the work of multiple teams achieving common objectives set by an organization. Such an embodiment is capable of supporting hundreds to thousands of users at multiple levels within the organization. Because the business owner/product owner/funder of projects has approved and agreed to the feature request of this work item, then the application and product teams know that they have permission to work on these items, and they can be filtered into their roadmap of their roadmap tool.

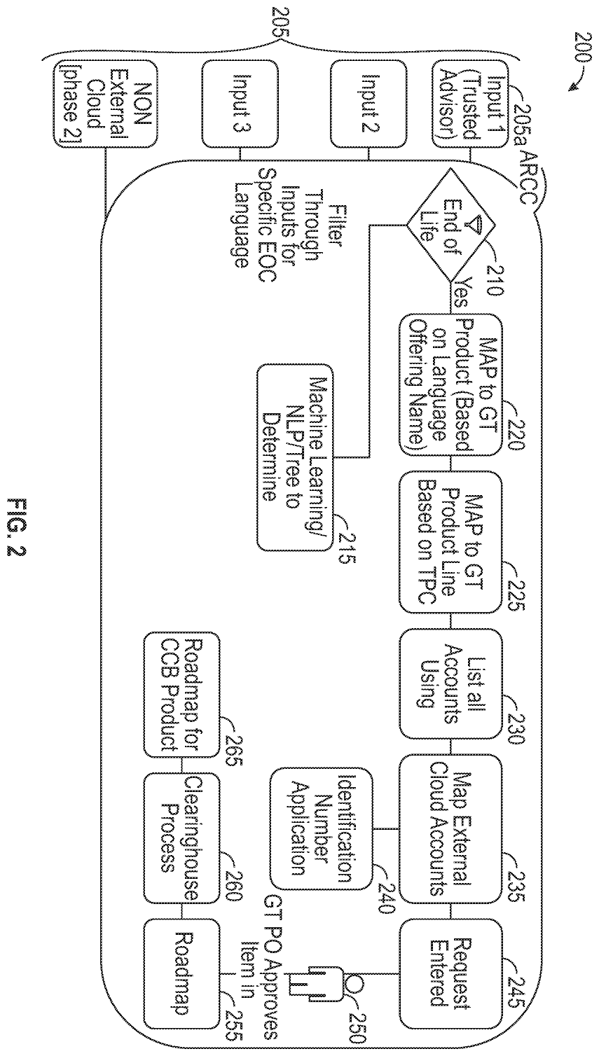

FIG. 2 illustrates a process for automating roadmap software content creation implemented by an ARCC tool 200, consistent with embodiments of the disclosure. In an exemplary embodiment, the method is executable on any networked computer platform, such as, for example, a personal computer (PC). The ARCC tool 200 may be a computer system. The ARCC tool 200 may store one or more applications that can include executable instructions that, when executed by the ARCC tool 200, cause the ARCC tool 200 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ARCC tool 200 itself, may be located in virtual server(s) running in a cloud-based computing environment rather than being tied to one or more specific physical network computing devices. Also, the application(s) may be running in one or more virtual machines (VMs) executing on the ARCC tool 200. Additionally, VMs running on the ARCC tool 200 may be managed or supervised by a hypervisor.

In FIG. 2, inputs from various data sources 205 can be transferred as inputs to the ARCC tool 200 of the internal cloud environment 120 during an intake process. According to the present disclosure, multiple mechanisms, techniques, and tools may be employed to gather information from various input data sources 205, such as external cloud input data sources and non-external cloud input data sources. The input data sources 205 can be configured to transfer the gathered data to the ARCC tool 200, for example, periodically at a pre-determined time, such as daily.

One example of an external cloud input data source is a Trusted Advisor tool 205a of an external cloud environment 105. The Trusted Advisor tool 205a is a web service that inspects a client's private VPC 130 and makes recommendations. The Trusted Advisor tool 205a evaluates the resources in the client's private VPC 130 by using pre-defined monitoring rules called “checks.” The Trusted Advisor tool 205a may check several categories of best practice compliance being cost optimization, performance, security, fault tolerance and service limits. After the checks are completed, the Trusted Advisor tool 205a provides recommendations. The ARCC tool 200 can receive the Trusted Advisor 205a tool check results for all the accounts in the client's organization and any affected resources.

Mechanisms other than the Trusted Advisor tool 205a may be used to input data into the ARCC tool 200. For example, input data may be received from Simple Notification Service (SNS) feeds and blog scraping and files sent by the internal cloud 120.

In various embodiments, in lieu of or in addition to the updates received from the external cloud environment 105 during the intake process, internal updates may be received from the internal cloud environment 120. The internal updates can be received from a multitude of mechanisms, techniques, and tools. Thus, the ARCC tool 200 can be used for any type of LCM updates that require action for the maintenance and upkeep of an application.

The input data received from the external cloud environment 105, the internal cloud environment 120, or both may include expiry data, which contains data regarding an announcement of the release of a new version of a software and an expiration date for the previous version. For example, the expiry data may include one or more expiration attributes to identify at least one of: an expiration date, the expiration date indicating a date when the data source is no longer available; a software version number associated with the expiration date; and a new software version of the data source at the external cloud environment 105; and LCM request data. The LCM data for an external cloud may indicate when the external cloud will no longer support a version or feature of the software or application and the appropriate internal groups of the company needs to be aware of the deprecation.

An end-of-life query 210 may determine whether the input data is an “end of life” or LCM type of activity that requires action. The input data may be filtered in various ways. The ARCC tool 200 can employ various filter techniques 215 to filter for the expiry data regarding an “end of life” announcement information. In an embodiment, the ARCC tool 200 can apply a search filter for relevant terms or key phrases to search for the expiry data. In some embodiments, the data may be filtered using, for example, machine learning, NLP and/or tree type algorithms techniques.

By way of example, FIG. 2 shows a set of GT product maps 220, 225 that maps to different data of the GT product. For instance, GT product map 220 may map to the GT product based on the offering name. GT product map 225 may map to the GT product line based on TPC. The use of GT product maps 220, 225 is optional, but in some embodiments it may be useful for entities that have central management of generic technology product lines, such as “databases” or “cloud offerings.”

The ARCC tool 200 needs to understand the GT ownership to update the item that needs to be upgraded by mapping to the GT product. As described above, to create a GT product map, the intake process may involve providing details for an offering about a product into the system, which includes offering name, offer description, overview of functionality, version number, and organizational details. The GT product map maps at least one item to be upgraded to the GT product data.

To generate the list of the internal products that need to be updated, a list of accounts 230 within the company or entity that are using the software or application scheduled to be upgraded may be obtained. For example, the ARCC tool 200 using the workflow tool 110a can create the content by generating a list of accounts for the software application being unsupported by the external cloud environment. The workflow tool 110a can create a list of external cloud accounts for private computing resources hosted on the external cloud environment 105 for exclusive use by a user in the VPC 130. The list is created by performing a software check on the private computing resources to determine the list of external cloud accounts associated with the software application being unsupported by the external cloud environment.

The workflow tool 110a can determine software programs installed on the external cloud environment 105 that are actively running or inactive and needing updates. In an embodiment, the workflow tool 110a can determine the list of external cloud accounts by mapping (Map 235) the list of external cloud accounts to line of business products with global technology ownership data.

In some embodiments, a list of internal accounts may be retrieved from a database within the internal systems. The internal cloud environment 120 may include other internal applications, as well. The process can also obtain a list of internal accounts from an identification number application 240 that maintains an internal software list, including software version and depreciation data indicating when a software application deprecates on the internal cloud environment 120.

The workflow tool 110a can further create the content by creating a roadmap items account list by mapping the list of external cloud accounts to the list of internal accounts.

After the roadmap items account list which identifies the internal products that need to be updated has been generated, the roadmap items account list from the workflow tool in the external cloud environment 105 may be sent to an internal workflow in the internal cloud environment 120 to notify the business owner or product owner to add this item for update into their roadmap. In the summary, the workflow tool 110a is configured to filter data from various data sources, for example, to determine which requests relate to an LCM, categorize and organize the request to specific internal accounts, products and LOBS, and generate a list of accounts to add the LCM items that need to be update to the roadmap tool.

In some systems, an internal product, such as a feature request tracking tool 245, or a convey tool, can be used to send the communications of the workflow tools from the external cloud environment to the internal cloud environment. To automate the process of keeping the roadmap up to date so that it remains accurate, in embodiments, the feature request tracking tool 245 can be used to track feature requests and inject roadmap items into the roadmap tool.

A disposition and/or approval 250 may be applied to the feature request to determine whether to inject the update item into the roadmap tool. The feature request may be assigned, for example, to a product owner for disposition and/or approval. The disposition options may include approve, conduct further research and/or evaluation, return to submitter or author requiring additional information, reject request, request not recommended, and request already exists in roadmap tool.

If approved, the feature request is injected into the roadmap tool 255. The roadmap tool communicates high-level strategic objectives and priorities for projects that the business has committed to. In an embodiment, the roadmap tool may be a project management tool. In some embodiments, the project management tool can include a feature request tracking tool to track feature requests and inject feature request items into the roadmap tool.

One embodiment provides a roadmap tool, such as JIRA, that works at the level of a team. Another embodiment provides a roadmap tool, such as JIRA Align, that works on a larger scale to coordinate the work of multiple teams achieving common objectives set by an organization. Such an embodiment is capable of supporting hundreds to thousands of users at multiple levels within the organization. Because the business owner/product owner/funder of projects has approved and agreed to the feature request of this work item, then the application and product teams know that they have permission to work on these items, and they can be filtered into their roadmap of their roadmap tool.

Clearinghouse process 260 is a vetting process to examine the request for work and facilitates their injection into a change control board (CCB) product roadmap 265 which may filter the work items to the work queue of the roadmap tool. The CCB is used to manage and oversee changes to a project. The CCB may consist of subject matter experts and managers from different parts of the organization. The CCB assesses the proposed product changes prior to implementation and makes sure that there are no negative impacts.

The ARCC tool 200 described herein may be applicable to create content for various types of roadmaps, for example, a business roadmap, a strategic roadmap, a portfolio roadmap, a features roadmap, an agile roadmap, a go-to-market roadmap, a marketing roadmap, an information technology (IT) projects roadmap, and a technology roadmap.

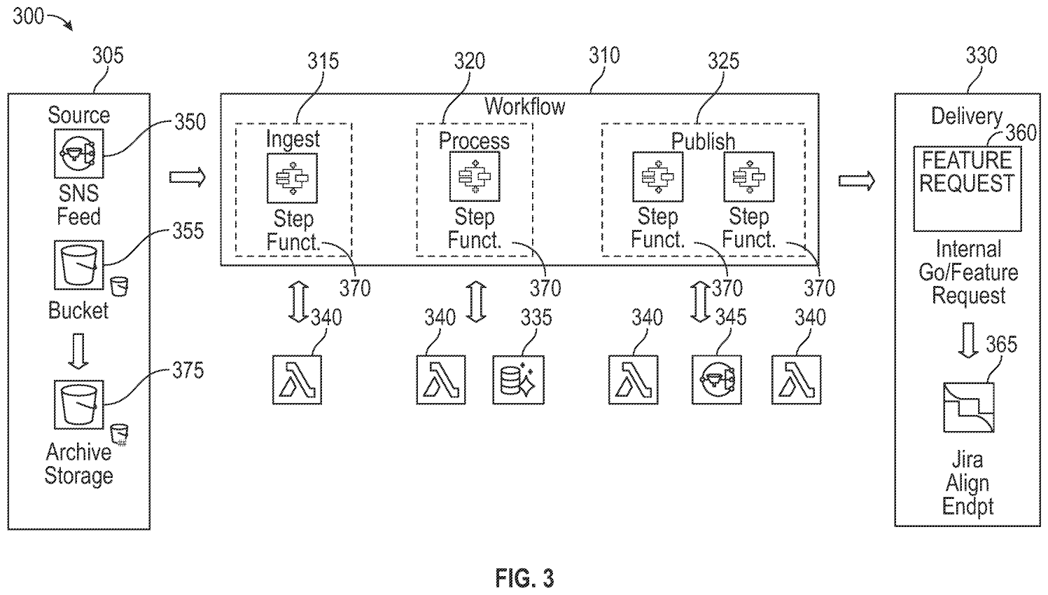

FIG. 3 illustrates an architectural diagram of an ARCC tool 300 described herein. The system and method of the ARCC tool 300 provides the creation of roadmap content including expiry data, which contains data regarding an announcement of the release of a new version of a software and an expiration date for the previous version. For example, the expiry data may include one or more expiration attributes to identify at least one of: an expiration date, the expiration date indicating a date when the data source is no longer available; a software version number associated with the expiration date; a new software version of the data source at the external cloud environment 105; and LCM request data.

In the example of FIG. 3, the ARCC tool 300 may include one or more workflows 310 that receive input data from various input sources 305 to process the LCM request for output using a delivery service 330 to various endpoints which can include, for example, a feature request tool 360 for conducting feature request approval and a roadmap tool 365. Real time updates to add the LCM request to the roadmap tool may include one or more workflows 310 between various input sources 305 and delivery of the request to an internal workflow in the internal cloud environment 120. The purpose may be to notify the business owner or product owner to add the LCM item for update into their roadmap tool 365. The workflow 310 can be configured to automate the population of the roadmap tool, such as JIRA or JIRA Align, by pushing the LCM requests (such as a feature request) into an approval workflow to determine whether or not to add these items to the backlogs by approving the request in the work approval tool.

In use, the ARCC tool 300 may be configured to initiate the one or more workflows 310. The workflows 310 may, in turn, invoke various operations of an ingest service 315, a process service 320 and a publish service 325. The workflow 310 may capture input data from the input sources 305, process service 320 and analyze them, integrate with multiple services and data stores 335 (e.g., relational databases), and publish the output for delivery service 330, via the publish service 325, to various endpoints in real-time. In some embodiments, the integrated data may then be stored in one or more databases.

The workflow 310 may employ many different ways to receive information to feed into the feature request tool 360. These ways may include, at least, the following two exemplary methods of (1) the external cloud computing environment sending to the internal cloud computing environment a consolidated file containing all the changes that the development team needs to implement the LCM request and (2) SNS feeds 345, 350.

In some embodiments, the input sources 305 may include cloud resources, streaming resources, computing resources, among other possible types of computing resources. The data of each resource can be automatically stored in buckets 355. For example, cloud resources can include computing resources (e.g., on-demand executable functions or other types of applications) that query one or more service provider network data sources to obtain the input data. In some embodiments, the input data generally includes any type of data including log data, security event data, files, and any other type of data managed or stored by one or more of a plurality of cloud services. The data files may remain in buckets 355 for a predetermined time, such as 90 days, after which the files can be automatically archived in a long-lived archive storage 375 by using bucket lifecycle rules.

In some embodiments, a data stream may transmit the input data from the input sources 305 to the ingest service 315, which may perform data filtering, identification, or normalization. For example, ingest service 315 may perform automated data ingestion with data preparation features to structure and organize the input data so it can be analyzed in real-time. Ingest service 315 may perform both batched and streamed ingestion of the incoming data.

This organized data may then be transmitted from the ingest service 315 to the process service 320 through the workflow 310 pipeline. The workflow 310 can be implemented using one or more relational databases 335 that includes one or more data stores, databases, and computing devices. In some embodiments, the relational databases 335 may be, for example, but not limited to, Dynamo Database and/or Aurora Database. The relational databases 335 can store information about datasets and/or rules used or supported by the workflow 310. Furthermore, the relational databases 335 can be used to, among other things, interpret dataset identifiers in a query, verify/authenticate a user's permissions and/or authorizations for different datasets, identify additional processing as part of the query, identify one or more source datasets from which to retrieve data as part of the query, determine how to extract data from datasets, identify configurations/definitions/dependencies to be used by search nodes to execute the query, etc.

In some embodiments, the automation can either be run by the ARCC tool 300 as part of the workflow 310 or by a user. Service provider on-demand executable functions (e.g., Lambda functions 340 executed by an on-demand code execution service) can be used to transform events and to bring context to the different data sources ingested, such as adding source type and source information to events. The Lambda function 340 can be a serverless computing service that runs code in response to events, such as changes in state or an update, and automatically manages the underlying computing resources. The Lambda function 340 can run functions independently of other code and output results directly to other functions, or for consumption by other services.

The ingest service 315, process service 320, and publish service 325 can be implemented by using one or more step functions 370. The step functions 370 can be a serverless orchestration service that coordinates multiple Lambda functions 340 into flexible workflows that are easy to debug and change. At each step in the workflow 310, the step functions 370 can manage input, output, error handling, and retries. The step functions 370 can log the state of each step. When things go wrong in the workflow 310, the step functions 370 can enable the problems to be quickly diagnosed and debugged.

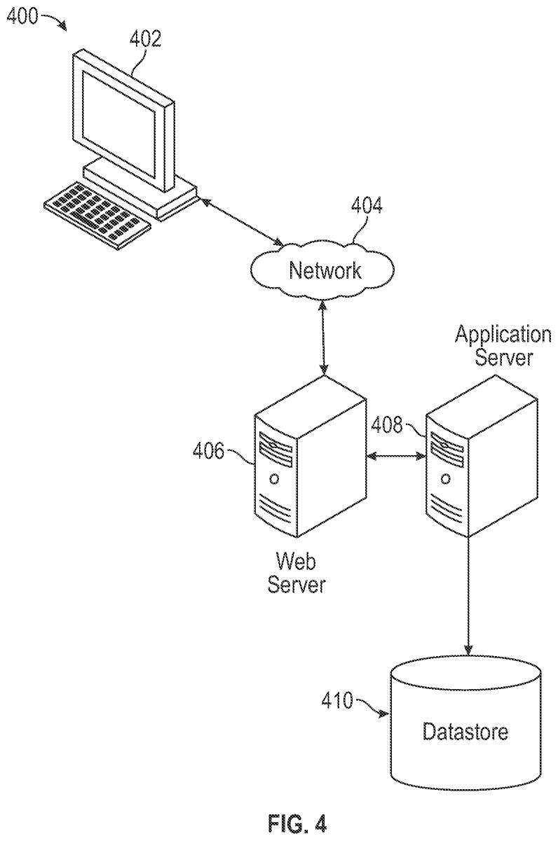

FIG. 4 illustrates aspects of an example computer environment 400 for implementing aspects in accordance with various embodiments. As will be appreciated, although a web-based environment is used for purposes of explanation, different environments may be used, as appropriate, to implement various embodiments. The computer environment 400 includes an electronic device 402, which can include any appropriate device operable to send and/or receive requests, messages, or information over an appropriate network 404. In some embodiments, an appropriate device may convey information back to the user of the device. Examples of such electronic device 402 include personal computers, cell phones, handheld messaging devices, laptop computers, tablet computers, set-top boxes, personal data assistants, embedded computer systems, electronic book readers, and the like.

The network 404 can include any appropriate network, including an intranet, the Internet, a cellular network, a local area network, a satellite network, or any other such network and/or combination thereof. Components used for such a system can depend at least in part upon the type of network and/or environment selected. Many protocols and components for communicating via such a network are well known and will not be discussed herein in detail.

Communication over the network can be enabled by wired or wireless connections and combinations thereof. In this example, the network 404 includes the Internet and/or other publicly addressable communications network, as the environment includes a web server 406 for receiving requests and serving content in response thereto, although for other networks an alternative device serving a similar purpose could be used as would be apparent to one of ordinary skill in the art.

The illustrative environment includes at least one application server 408 and a datastore 410. It should be understood that there may be several application servers, layers or other elements, processes, or components, that may be chained or otherwise configured, that can interact to perform tasks such as obtaining data from an appropriate data store.

Servers, as used herein, may be implemented in various ways, such as hardware devices or virtual computer systems. In some contexts, servers may refer to a programming module being executed on a computer system. As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The application server 408 can include any appropriate hardware/software/firmware for integrating with the datastore 410 needed to execute aspects of applications for the electronic device 402, handling some or all of the data access and logic for an application. The application server 408 may provide access control services in cooperation with the datastore 410. It can also generate content including, but not limited to, text, graphics, audio, video, and/or other content usable to be provided to the user. Such content may be served to the user by the web server in the form of Hypertext Markup Language (HTML), Extensible Markup Language (XML), JavaScript, Cascading Style Sheets (CSS), JavaScript Object Notation (JSON), and/or another appropriate client-side structured language.

Content transferred to an electronic device 402 may be processed by the electronic device 402 to provide the content in one or more forms including, but not limited to, forms that are perceptible to the user audibly, visually, and/or through other senses. The handling of all requests and responses, as well as the delivery of content between the electronic device 402 and the application server 408, can be handled by the web server using PHP: Hypertext Preprocessor (PHP), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 4. Thus, the depiction of the system illustrated in the example computer environment 400 in FIG. 4 should be taken as being illustrative in nature and not limiting to the scope of the disclosure.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” may also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for automating roadmap software content creation, the method comprising:
gathering data, by at least one processor, from one or more data sources;
filtering, by the at least one processor, the data based on a predetermined criteria to identify one or more requests to update a software application being unsupported by an external cloud environment; and
creating content automatically for a roadmap software tool, based on the one or more requests, by using a content generating workflow software tool.

2. The method of claim 1, wherein the predetermined criteria includes deprecation data comprising a deprecation status indicative of the software application being unsupported by the external cloud environment; and
wherein the deprecation data includes one or more attributes to identify the software application.

3. The method of claim 2, wherein the software application being unsupported is an internal software application running on at least one of a virtual private cloud, an internal cloud environment, and an internal computing environment.

4. The method of claim 1, wherein filtering the data further comprises using at least one of machine learning, natural language processing and tree algorithms.

5. The method of claim 1, wherein creating the content further comprises creating a global technology product map by mapping data of the software application being unsupported by the external cloud environment to global technology ownership data.

6. The method of claim 5, wherein creating the content further comprises creating a global technology product line map by mapping data of the software application being unsupported by the external cloud environment to global technology data.

7. The method of claim 3, wherein creating the content further comprises generating a list of accounts for the software application being unsupported by the external cloud environment.

8. The method of claim 7, wherein generating the list of accounts further comprises, for private computing resources hosted on the external cloud environment for exclusive use by a user, performing a software check on the private computing resources to determine a list of external cloud accounts associated with the software application being unsupported by the external cloud environment.

9. The method of claim 8, wherein determining the list of external cloud accounts further comprises mapping the list of external cloud accounts to line of business products with global technology ownership data.

10. The method of claim 9, wherein generating the list of accounts further comprises obtaining a list of internal accounts from an identification number application that maintains an internal software list, including software version and depreciation data indicating when a software application deprecates on the internal cloud environment.

11. The method of claim 10, wherein creating the content further comprises creating a roadmap items account list by mapping the list of external cloud accounts to the list of internal accounts.

12. The method of claim 11, further comprising sending the roadmap items account list from the content generating workflow software tool on the external cloud environment to an internal workflow tool on the internal cloud environment for approval to add one or more of the requests as one or more work items to the roadmap software tool.

13. The method of claim 12, wherein, after approval, adding the one or more work items to the roadmap software tool and filtering and prioritizing the one or more work items to a work queue of the roadmap software tool to update the feature of the software application being unsupported by the external cloud environment.

14. A computing device configured to implement an execution of a method for automating roadmap software content creation, the computing device comprising:
a processor;
a memory; and
a communication interface coupled to each of the processor and the memory,
wherein the processor is configured to:
gather data, by a processor, from one or more data sources;
filter, by the processor, the data based on a predetermined criteria to identify one or more requests to update a software application being unsupported by an external cloud environment; and
create content automatically for a roadmap software tool, based on the one or more requests, by a content generating workflow software tool.

15. The computing device of claim 14, wherein the predetermined criteria includes deprecation data comprising a deprecation status indicative of the software application being unsupported by the external cloud environment; and
wherein the deprecation data includes one or more attributes to identify the software application.

16. The computing device of claim 15, wherein the software application being unsupported is an internal software application running on at least one of a virtual private cloud, an internal cloud environment, and an internal computing environment.

17. The computing device of claim 16, wherein the content generating workflow software tool is further configured to create a roadmap items account list by mapping a list of external cloud accounts being unsupported by the external cloud environment to a list of internal accounts on the internal cloud environment.

18. The computing device of claim 17, wherein the content generating workflow software tool is further configured to send the roadmap items account list from the external cloud environment to an internal workflow tool on the internal cloud environment for approval to add one or more of the requests as one or more work items to the roadmap software tool.

19. The computing device of claim 18, wherein, after approval, the internal workflow software is further configured to add the one or more work items to the roadmap software tool and filter and prioritize the one or more work items to a work queue of the roadmap software tool to update the feature of the software application being unsupported by the external cloud environment.

20. A tangible computer-readable medium having stored thereon, computer executable instructions that, if executed by a computing device, cause the computing device to perform a method for automating roadmap software content creation, the method comprising:
gathering data, by at least one processor, from one or more data sources;
filtering, by the at least one processor, the data based on a predetermined criteria to identify one or more requests to update a software application being unsupported by an external cloud environment; and
creating content automatically for a roadmap software tool, based on the one or more requests, by using a content generating workflow software tool.
